(19) United States
(12) Patent Application Publication
(10) Pub. No.: US 2023/0339703 A1
(43) Pub. Date: Oct. 26, 2023

(54) APPARATUS AND METHOD FOR TRANSPORTING CONTAINERS WITH ROLLER-SUPPORTED ACTUATING MECHANISM FOR GRIPPING CLAMPS

(71) Applicant: KRONES AG, Neutraubling (DE)

(72) Inventors: Dirk HEINRICH, Burglengenfeld (DE); Thomas HOELLRIEGL, Teublitz (DE); Markus STIEGLER, Parsberg (DE); Hans-Juergen FLEISCHMANN, Steinberg am See (DE); Nina HABENSCHADEN, Regensburg (DE); Harald EFFENBERGER, Schierling (DE)

(21) Appl. No.: 17/899,472

(22) Filed: Aug. 30, 2022

(30) Foreign Application Priority Data
Nov. 17, 2021 (DE) 10 2021 129 959.4

(51) Int. Cl. B65G 47/86

(52) U.S. Cl. CPC B65G 47/847; B65G 2201/0244

(57) ABSTRACT

Disclosed is an apparatus for transporting containers, having a movable carrier on which a plurality of gripping devices for gripping containers are arranged, wherein these gripping devices being designed as gripping clamps, and these clamps each having at least two clamp arms which can be moved between a first position, in which they grip the containers to be transported, and a second position, wherein the gripping clamps having contact portions which are suitable and intended to contact the containers, and wherein furthermore an actuating mechanism is provided which is suitable for transferring the gripping means between the first position and the second position, characterized in that this actuating mechanism comprises at least one roller element which is arranged on at least one of the clamp arms and can be rotated with respect to this clamp arm and with respect to a predetermined axis of rotation.

### BACKGROUND OF THE INVENTION

The present invention relates to an apparatus and a method for transporting containers. A wide variety of apparatus and methods for transporting containers are known from the prior art. It is known that containers, for example plastic bottles, are gripped at their mouths and transported. For example, transfer stars (also known as neck-handling stars) are known from the prior art, which are used with a similar mode of operation in container handling machines everywhere in order to transport containers and in particular bottles in or outside the machines or modules.

These neck handling stars usually have a plurality of clamp elements attached to a disc or similar receptacle. The assembly or drive via a drive axle, which is for example a star column, usually has its own motor or is driven by belts. To open or close these clamps, a roller and cam with a lever is used, for example.

Currently, many systems from various sectors or machine types are in use that no longer achieve the desired service life at high speed or can no longer withstand the mechanical loads. The control of such clamps, which is usually designed with a rotary cam, wears out relatively quickly due to sliding friction.

In addition, mechanisms are also provided in some cases, for example via two leaf springs that press on a rotary cam. This results in a certain sliding friction. When triggered to open, the rollers only touch the lever briefly and the clamps spring open via the spring force of the leaf springs. As a result, the roller loses contact with the lever and no further accompanying movement is possible, causing the clamps to open jerkily and the lever to strike against a stop pin, which serves as a rollover limit. This causes the lever to swing back and forth a little more until it reaches its final position. However, the required precision is usually insufficient for high-speed transport starwheels.

### SUMMARY OF THE INVENTION

The present invention is therefore based on the object of reducing the wear of such systems, also for high-speed applications. This object is achieved according to the invention by the subject matters of the independent patent claims. Advantageous embodiments and further developments are the subject matter of the subclaims.

An apparatus according to the invention for transporting containers has a movable and in particular rotatable carrier on which a plurality of gripping devices for gripping containers are arranged, wherein these gripping devices are designed as gripping clamps and these gripping clamps each have at least two clamp arms which can be moved between a first position in which they grip the containers to be transported and a second position, wherein said gripping clamps comprise contact portions which are suitable and intended to contact said containers (in particular in said first position) and wherein at least one actuating mechanism is provided which is suitable to transfer said gripping device between said first position and said second position (and/or to transfer said gripping device from said first position to said second position and/or to transfer said gripping device from said second position to said first position).

According to the invention, this actuating mechanism comprises at least one roller element arranged on at least one of the clamp arms and rotatable with respect to this clamp element and with respect to a predetermined axis of rotation.

It is therefore proposed that an actuating mechanism is used to open and close the gripping devices, which has a roller element on the gripping device (or on an element and/or section of the gripping device) itself. In this way, a transfer from a first position of the gripping device to a second position of the gripping device can take place by means of a rolling movement.

Preferably, the first position is a closed and/or gripping position in which the containers are gripped and the second position is a released position in which the gripping devices are preferably not engaged with the containers (and/or the containers are removable from or attachable to the gripping devices). Particularly preferably, the containers are plastic bottles and/or glass bottles. However, it would also be possible for the gripping devices to grip plastic preforms.

The new transport devices or transfer starwheels according to the invention are more wear-resistant and more precise from the clamp guide or bearing with a new control. The gripping devices or clamp devices are preferably controlled by a cam, which may be made of metal, for example, and which transmits this movement to the roller device mentioned here, which is arranged in a region of the gripping device, for example at the end of the clamp, and initiates opening and/or closing. Here, less wear occurs on the functional parts due to the rolling friction.

In a preferred embodiment, at least one roller element rotatable with respect to the respective clamp arm and with respect to a predetermined axis of rotation is arranged on both clamp arms. In this embodiment, both clamp arms are moved by the actuating mechanism and both clamp arms are moved using said roller elements.

In a preferred embodiment, the axis of rotation of at least one roller element is perpendicular to a plane of movement in which the gripping clamps can be moved to open and close the gripping device. Preferably, the axis of rotation is parallel to the longitudinal direction of the containers to be transported. Preferably, said axis of rotation is perpendicular to the transport plane of the containers.

Preferably, the roller element is arranged in a recess which is formed in a section of the respective clamp arm. Preferably, this recess completely surrounds at least one section of the roller element. Preferably, the respective clamp arm has a cavity which is completely surrounded by the material of the clamp arm and the roller element is integrated in this cavity. In this way, a particularly stable mounting of the roller element is possible.

In a further advantageous embodiment, the containers have a main body and a mouth area with an opening, and the gripping devices are suitable and intended for gripping the containers in this mouth area.

Preferably, the at least one roller element has an outer cross-section selected from a group of outer cross-sections including circular cross-sections, elliptical cross-sections, polygonal cross-sections and the like. Particularly preferably, at least one roller element and preferably both roller elements have a circular cross-section.

In a further preferred embodiment, the gripping devices and/or the gripping clamps are exchangeably arranged on the carrier. In this way, on the one hand a changeover to other containers would be possible, but on the other hand also a replacement for maintenance purposes.

In a further preferred embodiment, the first clamp arm is pivotable with respect to a first pivot axis and the second clamp arm is pivotable with respect to a second pivot axis, wherein preferably these pivot axes coincide or are parallel to each other. For example, it becomes possible for the two clamp arms to be crossed in the pivot axis. In addition, however, it would also be possible for the two pivot axes to be parallel to each other. In this case, preferably the pivot axes have a distance from each other that is greater than 1 mm, preferably greater than 3 mm, preferably greater than 5 mm. Particularly preferably this distance is less than 10 cm, preferably less than 8 cm, preferably less than 5 cm.

Preferably, the clamp arms are designed and/or arranged symmetrically to each other.

Particularly preferably, the at least one pivot axis is arranged in an extension direction of the gripping clamp between the contact sections and the roller elements. The extension direction of the gripping clamp is preferably understood to be a direction that also represents an axis of symmetry of the gripping clamp or a plane of symmetry.

In a further advantageous embodiment, the actuating mechanism has a movable and, in particular, rotatable actuator whose movement can be transmitted—preferably directly—to the at least one roller element and preferably to both roller elements. Particularly preferably, this movable actuator is made of metal. In a further advantageous embodiment, at least one roller element and preferably both roller elements have a rubber outer surface or an outer surface made of a plastic and/or elastomer.

Preferably, the actuator is arranged between the two roller elements. In a further preferred embodiment, the actuator can be rotated through 360° and particularly preferably through more than 360° in one direction of rotation. Preferably, the actuator causes the gripping device to open and close alternately when it is rotated in the same direction.

In a further preferred embodiment, the actuator is an actuator that can be moved back and forth along a predetermined path of movement and is preferably in contact with the roller element or elements. This reciprocating movement of the actuator preferably causes the gripping device to open and close.

In a further preferred embodiment, the actuator is in contact with the roller element(s) and a movement of the actuator relative to the roller elements causes a rotational movement of the roller elements. Preferably, rolling friction occurs between the actuator and the roller element(s).

In a further advantageous embodiment, the actuator is coupled to a lever element. Thus, a lever element can be provided which can be pivoted or rotated, whereby said actuator is also rotated at the same time. Preferably, the lever element is coupled to the actuator in a rotationally fixed manner.

In a further preferred embodiment, the actuator is rotatably mounted by means of a bearing device.

In a further advantageous embodiment, the gripping device has at least one resilient element, for example a spring, which causes contact to be made between the roller elements and the actuator. Furthermore, it would also be possible for said actuator to be controlled by cam segments. In addition, however, a fixation via magnets would also be conceivable.

In a preferred embodiment, the actuator is a cam which is actuated via a lever with a back and forth swivel over a roller. This actuation can also be done rotationally with a so-called cross lever, which is only actuated from one position of the actuation roller (for example at the transfer point where a container is transferred).

Preferably, this cross lever is rotated further by one cycle (90°) each time the rollers are approached, and so it remains in an open position once and in a closed position the next time it is actuated.

This position is preferably held with a latching function in a cam, which particularly preferably has a recess. In a further preferred embodiment, the cam and/or the clamps have a spring suspension in order to provide a certain pre-tension on the cam system and to ensure engagement, including gap-free closing of the clamps. Preferably, this spring cam has a spring which is preferably provided in the axis of rotation and thereby presses the gripping clamps against the control rollers of the clamps.

In a further preferred embodiment, the resilient clamp devices have a specially machined contour which gives a spring effect on the attached control roller and here also exerts a certain preload on the cam, which in this case is preferably rigid.

In a further embodiment, the opening and closing movement can be carried out with a slide and a roller control or cam lever. In a preferred embodiment, the control is carried out with a roller that is seated in a type of lever and is controlled via two stationary cam segments. Preferably, a driver is located in the deflecting part of the lever, which actuates a slider with a cam contour linearly or in a curved direction and opens or closes the gripping devices via the rollers.

In the two end positions, the roller lever (i.e. the actuator) or the clamp is engaged or fixed by another possible component, for example a magnet or a latching piece.

In a further preferred embodiment, the sliding system is identical and the control is actuated with a type of cam lever. Here, two stationary rollers are provided which actuate the cam lever and the slider when passing.

In addition, there can also be a closing function with a curve-cam segment, which is preferably located and controlled directly on a control lever.

In a further version, a sliding element can also be held in an end position (in particular clamp closed) via a magnetic holding system and the end position can be adjusted. In this sliding element, the functional surface can be trapezoidal in shape in order to be able to readjust any wear.

The invention achieves less wear due to rolling friction and more precise handling due to an improved clamp bearing. Due to the preferred pretensioning of the clamps or clamp arms, a secure and precise closing and engagement of the clamps or clamp arms can be achieved.

With the novel rotary system described here (for example a cross lever) of the control, a hitting of the control lever of the cam, or an impact, on the limiting bolt can be prevented.

Preferably, the cross lever guides the movement when passing the roller, as it wraps around it. Preferably, an accompanying movement of the roller to the lever (via rolling friction) is provided.

With the system, only one roller position per transfer is necessary. In addition, it is also possible that four contact surfaces are provided instead of only two in the case of a swivel lever, if a cross lever is used.

Preferably, in this case, a complete rotational movement takes place instead of a constant swinging back and forth. In the case of the swivelling lever, an additional pressure piece can preferably prevent the lever from overturning against a stop pin.

In the sliding system, which is also described in more detail below, no control levers are used, but rather preferably larger control rollers are installed, which enable an uniform rolling or a flatter approach angle to the cam lever or the cam segments. In this way, smooth running and less wear can be expected. Furthermore, it is possible to provide an adjustment option for the holding segment.

The present invention is further directed to a gripping device for gripping containers. This gripping device is designed as a gripping clamp, and this gripping clamp comprises at least two clamp arms which are movable between a first position, in which the gripping device grips the containers to be transported, and a second position, wherein the gripping clamps comprise contact sections which are suitable and intended for contacting the containers, and wherein furthermore an actuating mechanism is provided which is suitable for transferring the gripping devices between the first position and the second position.

According to the invention, this actuating mechanism comprises at least one roller element rotatable on at least one of the clamp arms with respect to this clamp arm and with respect to a predetermined axis of rotation.

In a preferred embodiment, the clamp arms have mirror-image geometries. Preferably, a roller element is arranged on both clamp arms. Particularly preferably, the roller elements on the clamp arms are of the same or identical design.

The present invention is further directed to a system for treating containers comprising a first treatment unit which treats the containers in a first predetermined manner and a second treatment unit which treats the containers in a second predetermined manner. According to the invention, the installation comprises a transport device of the type described above, which transports the containers from the first treatment unit to the second treatment unit.

The first treatment unit may be a treatment unit selected from a group of treatment units comprising forming devices for forming plastic containers into plastic bottles, sterilising devices for sterilising containers, filling devices for filling containers, closing devices for closing containers or the like.

The present invention is further directed to a method for transporting containers with a movable and in particular rotatable carrier, on which a plurality of gripping devices for gripping containers are arranged, wherein these gripping devices are designed as gripping clamps, and these clamps each comprise at least two clamp arms, which are moved between a first position, in which they grip the containers to be transported, and a second position, wherein the gripping clamps having contact sections which contact the containers, and wherein furthermore an actuating mechanism transferring the gripping devices between the first position and the second position.

According to the invention, this actuating mechanism comprises at least one roller element rotatable on at least one of the clamp arms with respect to this clamp arm and with respect to a predetermined axis of rotation.

Preferably, the at least one roller element cooperates with an actuator to open and/or close the gripping device. In a further preferred method, opening and closing is effected by a rolling contact of the roller element with a further element. This further element (which is in particular the above-mentioned actuator) can perform both a rotational movement and a displacement in a predetermined displacement direction.

### BRIEF DESCRIPTION OF THE DRAWINGS

Further embodiments and advantages can be seen in the attached drawings:

In the drawings:

FIG. 1 shows a representation of a transport device;

FIG. 2a, 2b show two illustrations of gripping devices according to the state of the art;

FIG. 3 shows a representation of a gripping device in a first embodiment;

FIG. 4 shows a sectional view of a gripping device;

FIG. 5 shows a further illustration of a gripping device according to the invention in a second embodiment;

FIG. 6 shows a further view of the gripping device shown in FIG. 5;

FIG. 7a, 7b show the representations of two clamp arms;

FIG. 8 shows a sectional view of a gripping device;

FIG. 9 shows a further sectional view of a gripping device;

FIG. 10 shows a representation of a transport device;

FIG. 11 shows a further illustration of a gripping device in a further embodiment;

FIG. 12 shows a representation of a gripping device with actuating device;

FIG. 13a, 13b show two illustrations of a gripping device in a further embodiment;

FIG. 14 shows a representation of a further embodiment of a gripping device;

FIGS. 15a-15d show four illustrations of a gripping device;

FIG. 16a, 16b show two illustrations of a gripping device in a further embodiment;

FIG. 17a, 17b show two further illustrations of a gripping device.

### DETAILED DESCRIPTION OF THE INVENTION

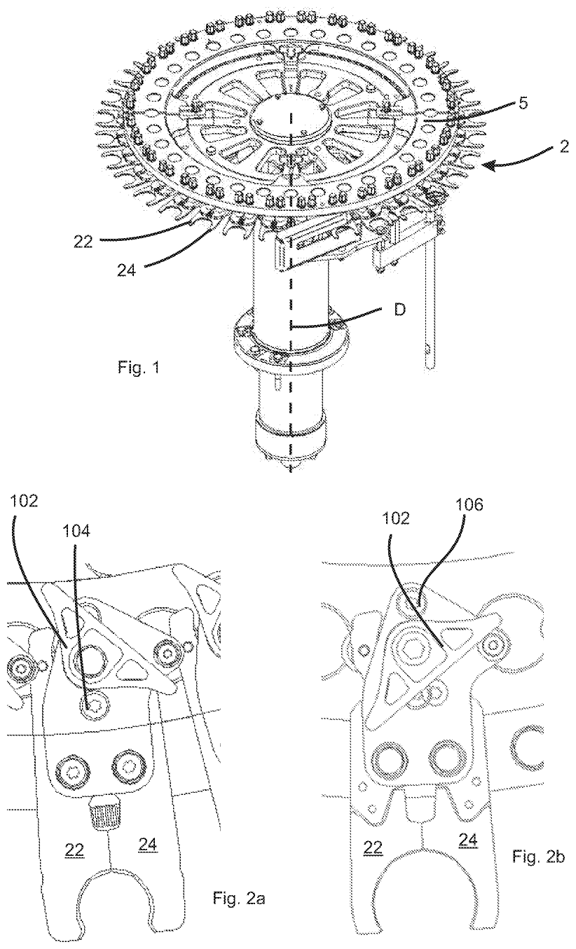

FIG. 1 shows an apparatus 1 for transporting containers (not shown). The reference sign 4 indicates a rotatable carrier on which a plurality of gripping devices 2 are arranged, which here have two gripping clamps 22, 24. The carrier 4 is rotatable with respect to an axis of rotation D.

FIGS. 2a and 2b show two representations of gripping devices according to the state of the art. These have a pivoting actuator 102, which here can be switched to two different positions by two cams 104 and 106 in order to open or close the gripping device. This means that opening and closing is performed by sliding friction.

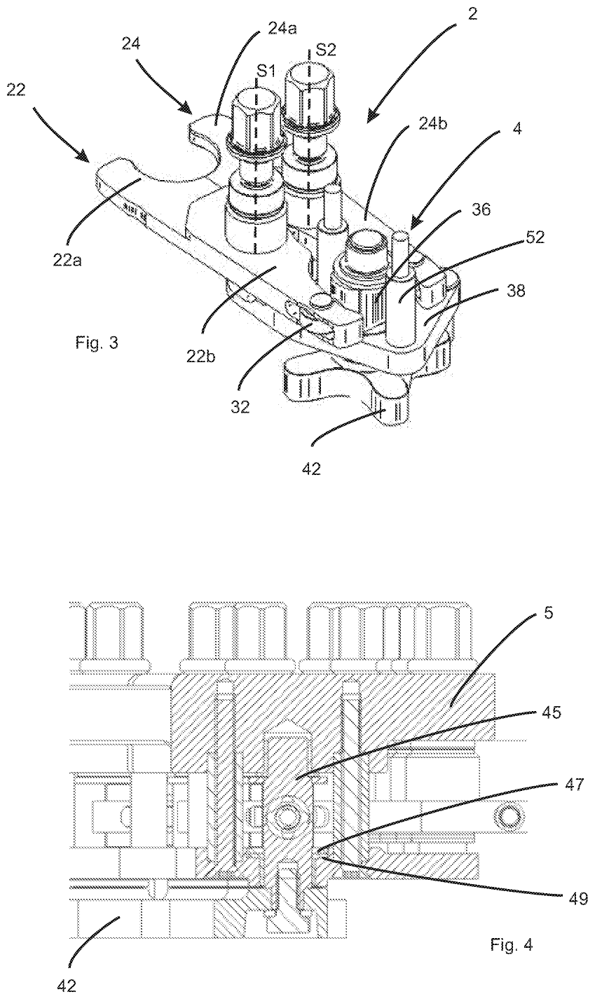

FIG. 3 shows an illustration of a gripping device 2 according to the invention. This has two clamp arms 22, 24, which in turn have contact sections 22a, 24a that contact the (not shown) containers.

The reference signs S1 and S2 indicate two pivot axes about which the clamp arms 22, 24 can be pivoted. The reference signs 22b and 24b indicate further sections of the clamp arms 22, 24 via which the opening and closing movement is initiated. For this purpose, roller elements 32, 34 (34 not shown) are arranged at these sections. The reference sign 36 indicates an actuator which contacts these roller elements for opening and closing the gripping device. The actuator is in turn connected to a (cross) lever 42. This lever 42 can be rotated by cams and thus cause the gripping device to open and close.

In the embodiment shown here, the lever 42 can be rotated further and, depending on the rotational position, the clamp passes from an open to a closed state or from a closed state to an open state, respectively. The reference sign 38 indicates a carrier on which the actuator 36 is arranged or mounted. The reference sign 4 identifies the actuating mechanism of the gripping device in its entirety. This means that opening and closing is achieved by rotating the actuator 36 with respect to an axis of rotation.

FIG. 4 shows a sectional view of the gripping device shown in FIG. 3. In particular, the rotatable bearing of the actuator can be seen. More precisely, a rotatable pin 45 can be seen, which is connected to the carrier 5 and also to the lever 42 in a rotationally fixed manner. This bearing preferably also has a plain bearing socket 49 and/or a disc 47 (which keeps the spring-loaded jaws level).

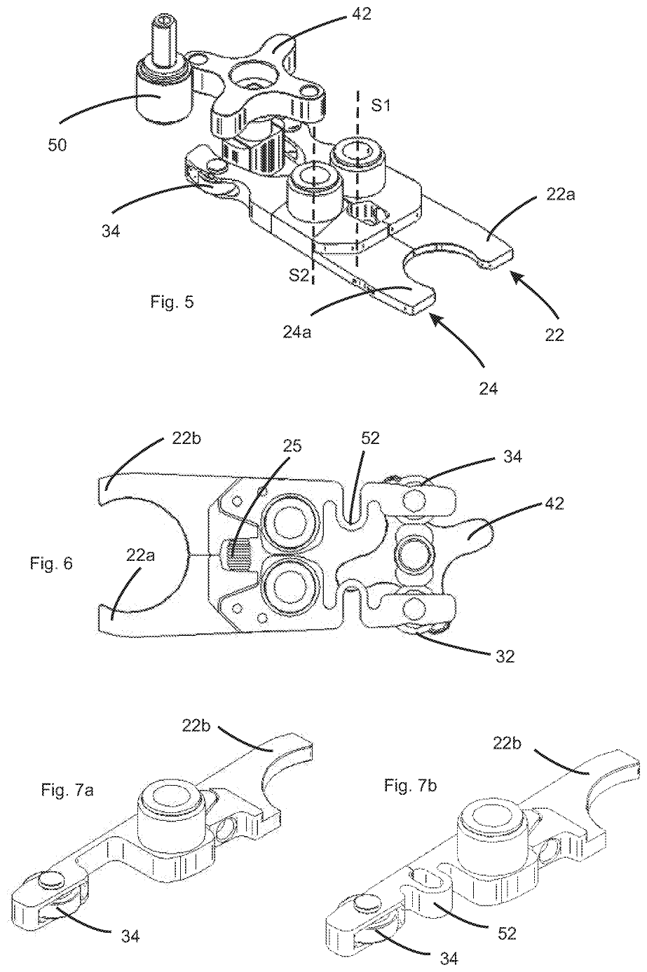

FIG. 5 shows a further design of a gripping device. Here again, the rotary lever 42 is provided, which can be moved one position further by a cam 50 in order to open or close the gripping device. FIG. 5 also shows the second roller element 34, which is arranged on the clamp arm 24.

FIG. 6 shows a top view of the gripping device from FIG. 5. In this design, the two roller elements 32 and 34 can be seen, which are contacted by a rotation of the rotary lever 42 and thus switch the gripping device between an open and a closed position. The reference sign 25 indicates a spring element which forces the gripping device into an open position. The reference sign 52 indicates further resilient sections which provide a secure hold or engagement of the roller elements with the actuator 36 or pretension these sections towards the actuator. You can see recesses of the actuator which define latching positions.

FIGS. 7a and 7b show the two clamp arms, wherein here also the roller elements 34 and 32 are shown. In the illustration shown in FIG. 7b, the additional spring element 52 can also be seen.

Due to the spring 25 between the two clamps, the two halves spring open directly after activation. Thus, there would no longer be any accompanying movement of the rollers on the control element 36 (cf. FIG. 3).

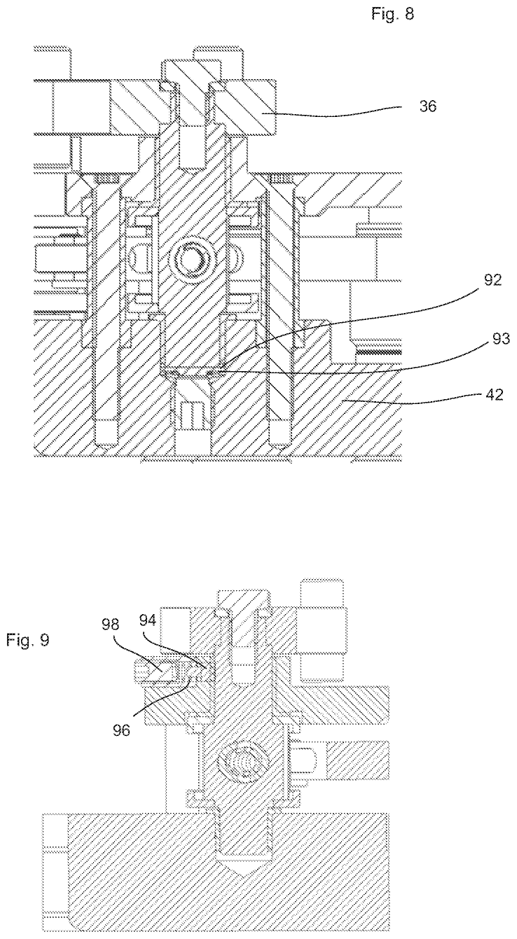

FIG. 8 shows another sectional view of the gripping device shown in FIG. 7.

A sliding disc 92 in the lower bearing position can create friction on the actuator 36. This reduces the overturning of the lever (FIG. 2b position 102) against the stop pin (also shown in FIG. 2b) when opening the clamps. The sliding disc 92 is preferably pressed against the bolt by means of disc springs 93. The spring force can be adjusted via a threaded bolt.

FIG. 9 shows another sectional view of the gripping device. Here, too, an additional pressure piece 94 can be seen that reduces the overturning of the lever. The pressure piece can press on the bolt from below as well as from the side. The reference sign 98 indicates an adjusting screw and the reference sign 96 indicates a spring.

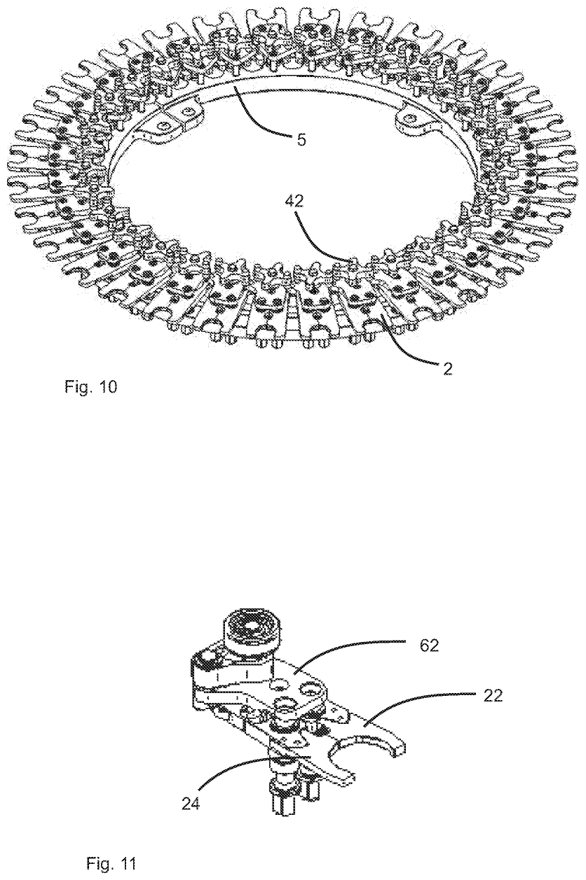

FIG. 10 shows a transport device with gripping devices 2 according to the invention. The reference sign 5 indicates a carrier on which the individual gripping devices 2 are arranged. The reference sign 42 indicates the rotary lever which is used to open and close the gripping devices.

FIG. 11 shows a further embodiment of a gripping device, wherein here again the two clamp arms 22, 24 are shown, as well as part of an actuating mechanism in the form of a carrier 62. Unlike the above embodiments, here opening and closing of the gripping device is effected by a displacement of an actuator. However, the roller elements are also provided here.

FIG. 12 illustrates the operation of the gripping devices of this design. Whereas in the previous designs opening and closing is effected by turning a cross lever, here it is effected by a linear movement or movement along a path of movement. For this purpose, another cam roller 64 is arranged on the gripping device.

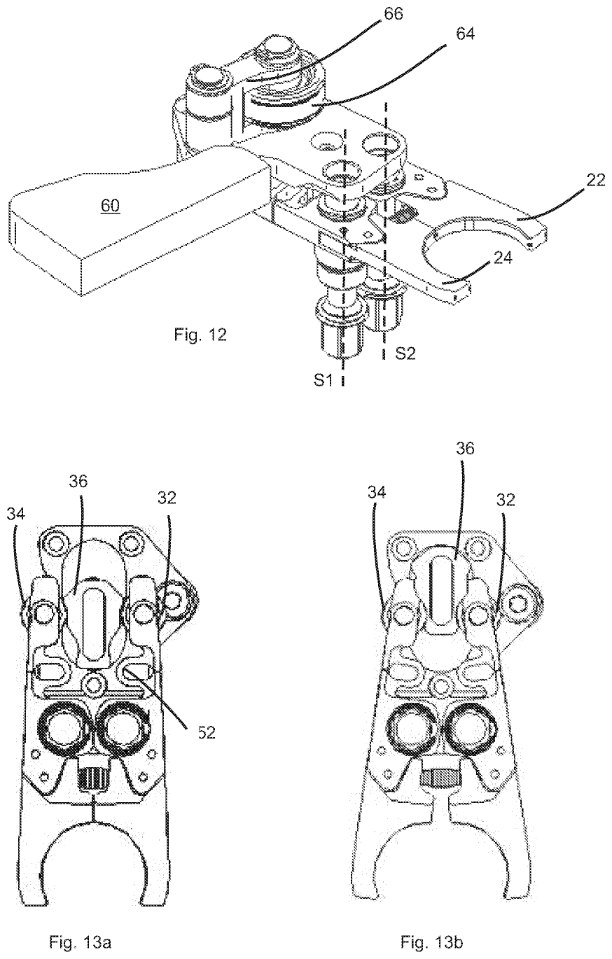

FIGS. 13a and 13b show an open and closed position of the gripping device. You can see the actuator 36, which is in two different positions in FIGS. 13a and 13b. This actuator causes the gripping clamp to open via the roller elements 32 and 34, i.e. the roller elements also roll here in relation to the actuator. The movement of this actuator 36 is achieved by the roller 64 and a (for example constant or stationary) cam 60.

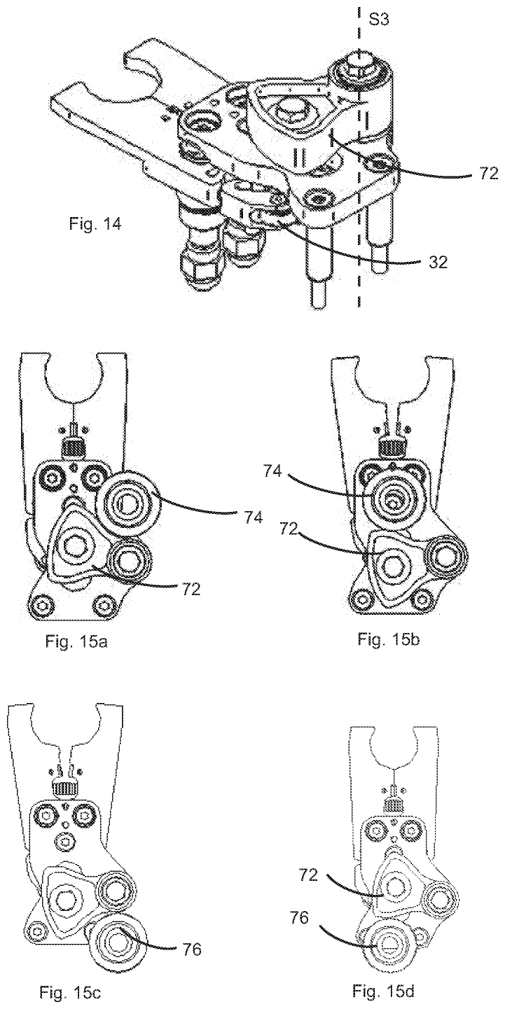

FIG. 14 shows a further design of a gripping device, wherein opening and closing is also achieved here by a back and forth movement of an actuator. For this purpose, a movable body 72 is provided, which can be pivoted with respect to a pivot axis S3.

FIGS. 15a and 15b show the transfer of the gripping device by a first cam 74, which here moves the lever 72 from an upper to a lower position and thus also triggers the opening and closing or, in this case, the transfer from an open position to a closed position.

FIGS. 15c and 15d show the opposite way of closing, wherein here the lever is pivoted upwards again by a further guide roller 76 in order to transfer the gripping device from the open to a closed position.

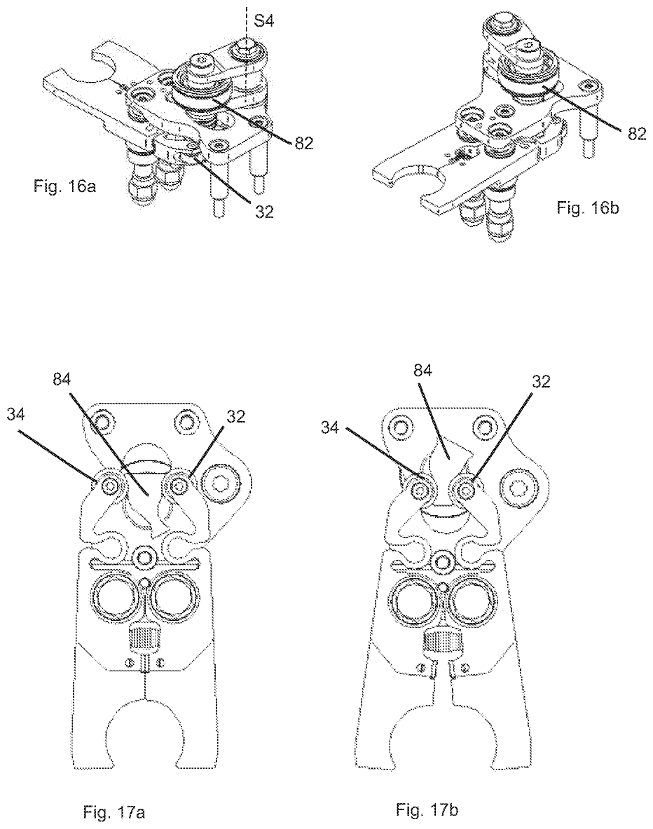

FIGS. 16a, 16b show a further design of the gripping device. Here, the opening and closing function is equipped with a cam segment 82, which is arranged here directly on the control lever. By pivoting the element 82, a shift from the opening to the closing position is achieved.

FIGS. 17a and 17b accordingly show the movement of the actuator 84 to transfer the gripping device from a closed position (cf. FIG. 17a) to an open position (cf. FIG. 17b). This actuator or sliding element can also be held in an end position (clamp closed) here and also in the above embodiments via a magnetic holding system.

The applicant reserves the right to claim all features disclosed in the application documents as essential to the invention, provided that they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1. An apparatus for transporting containers, having a movable carrier on which a plurality of gripping devices for gripping containers are arranged, wherein these gripping devices being designed as gripping clamps, and these clamps each having at least two clamp arms which can be moved between a first position, in which they grip the containers to be transported, and a second position, wherein the gripping clamps have contact sections which are suitable and intended for contacting the containers, and wherein further an actuating mechanism is provided which is suitable for transferring the gripping devices between the first position and the second position,
wherein
this actuating mechanism has at least one roller element which is arranged on at least one of the clamp arms and can be rotated with respect to this clamp arm and with respect to a predetermined axis of rotation.

2. The apparatus according to claim 1,
wherein
at least one roller element is arranged on both clamp arms, which is rotatable with respect to this respective clamp arm and with respect to a predetermined axis of rotation.

3. The apparatus according to claim 1,
wherein
the axis of rotation of at least one roller element is perpendicular to a plane of movement in which the gripping clamps are movable for opening and closing the gripping device.

4. The apparatus according to claim 1,
wherein
the containers comprise a main body and a mouth region with an opening and the gripping devices are suitable and intended for gripping the containers in the mouth region.

5. The apparatus according to claim 1,
wherein
the at least one roller element has an outer cross-section selected from a group of outer cross-sections including circular cross-sections, elliptical cross-sections, polygonal cross-sections.

6. The apparatus according to claim 1,
wherein
the gripping devices and/or the gripping clamps are exchangeably arranged on the carrier.

7. The apparatus according to claim 1,
wherein
the first clamp arm is pivotable with respect to a first pivot axis and the second clamp arm is pivotable with respect to a second pivot axis, wherein these pivot axes coinciding or being parallel to each other.

8. The apparatus according to claim 7,
wherein
the at least one pivot axis is arranged in an extension direction of the gripping clamp between the contact sections and the roller elements.

9. The apparatus according to claim 1,
wherein
the actuating mechanism comprises a movable actuator, the movement of which can be transmitted directly to the at least one roller element.

10. The apparatus according to claim 1,
wherein
this actuator is coupled to a lever element.

11. A gripping device for gripping containers, wherein the gripping device is designed as a gripping clamp, and this gripping clamp has at least two clamp arms which can be moved between a first position, in which it grips the containers to be transported, and a second position, wherein the gripping clamps have contact sections which are suitable and intended for contacting the containers, and wherein furthermore an actuating mechanism is provided which is adapted to transfer the gripping device between the first position and the second position,
wherein
this actuating mechanism comprises at least one roller element which is rotatable on at least one of the gripper arms with respect to said gripper arm and with respect to a predetermined axis of rotation.

12. The gripping device according to claim 1,
wherein
the clamp arms have geometries that are mirror images of one another.

13. An installation for treating containers, comprising a first treatment unit Which treats the containers in a first predetermined manner and a second treatment unit Which treats the containers in a second predetermined manner,
wherein
the installation comprises a transport device according to claim 1, which transports the containers from the first treatment unit to the second treatment unit.

14. A method for transporting containers with a movable carrier on which a plurality of gripping devices for gripping containers are arranged, wherein these gripping devices are designed as gripping clamps, and these clamps each have at least two damp arms Which are moved between a first position in which they grip the containers to be transported and a second position, wherein the gripping clamps have contact sections which contact the containers and wherein furthermore an actuating mechanism transfers the gripping devices between the first position and the second position,
wherein
this actuating mechanism has at least one roller element which is rotatable on at least one of the clamp arms with respect to this clamp arm and with respect to a predetermined axis of rotation.
